(19) United States
(12) Patent Application Publication
(10) Pub. No.: US 2008/0218854 A1
(43) Pub. Date: Sep. 11, 2008

(54) STEREOSCOPIC DISPLAY DEVICE

(76) Inventors: Takeshi Hoshino, Kodaira (JP); Rieko Otsuka, Fuchu (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/839,201

(22) Filed: Aug. 15, 2007

(30) Foreign Application Priority Data
Mar. 8, 2007 (JP) 2007-058926

(51) Int. Cl. G02B 27/24

(52) U.S. Cl. 359/462

(57) ABSTRACT

A mirror is provided on flat side surfaces of a polygonal conic surface, respectively, to form a polygon mirror. Moreover, in a flat panel display, planar real images are displayed facing the respective mirrors of this polygon mirror, and these planar real images are arrayed in a ring shape about the center axis of the polygonal conic surface to form an image ring. An observer can view such planar real image via the mirror facing thereto. Here, each planar real image of the image ring is an image of the same object viewed from a different direction, and the angle of inclination and the like of the polygonal conic surface is set so that all the mirror images of such planar real images by the mirrors are produced at the center axis of the polygonal conic surface.

### BACKGROUND OF THE INVENTION

The present invention relates to stereoscopic display devices that allow a person to view different side surfaces of a displaying target as the person views a displayed image while moving therearound and that allows for stereoscopic view.

There have been proposed display devices that display a stereoscopic image by using a rotating screen. As an example, a display device prepares, from three-dimensional image data representing a three-dimensional object, two-dimensional image data of this object viewed from different directions therearound (incidentally, when preparing such two-dimensional image data from three-dimensional image data, a hidden-surface-removal processing for erasing data of the unseen portions is carried out), and then sequentially projects the two-dimensional image data onto a rotating screen. Here, along with a change in the direction of the screen due to the rotation, the two-dimensional images projected thereto is changed sequentially. According to this device, when the screen is seen from one certain point, an image displayed on the screen will gradually change by speeding up the rotation of the screen. By carrying out the image displaying in this manner, the projected image on the screen appears to be a three-dimensional image due to the afterimage effect of the visual sense. (for example, see JP-A-2001-103515).

Moreover, as in the technique described in JP-A-2001-103515, in the case where two-dimensional images are projected by rotating a screen so as to obtain three-dimensional image, if the luminance distribution of the two-dimensional image to project is uniform, then in the image projected onto the screen, the farther away from the axis of rotation, further the luminance decreases as compared with the luminance on the rotation axis side of the screen and thus the luminance distribution becomes nonuniform. In order to prevent this, there has been also proposed a technique, wherein the luminance distribution of two-dimensional image to project is made nonuniform so as to make uniform the luminance distribution of the projected image onto the screen (for example, see JP-A-2002-27504).

Moreover, there has been also proposed a technique, wherein a displaying target is imaged from different viewpoints to obtain respective slide images and each time a rotating screen turns to these viewpoints sequentially, the slide image that was imaged from the corresponding viewpoint and obtained is projected, and then by increasing the rotational speed of the screen to about 300 to 600 rpm, afterimages of the naked eye are induced to form a pseudo three-dimensional image on the screen, or by continuously imaging a displaying target with a camera circularly moving therearound, a cylindrical film of the imaged images is prepared and then the images of such cylindrical film is read sequentially, and these images are image-formed at a position in the space via a mirror rotating in synchronization with the reading of the cylindrical film, and then by increasing the rotational speed of this mirror sufficiently, a three-dimensional image floating in the space is produced due to the afterimage of the naked eye (for example, see JP-A-2002-271820).

Moreover, there has been also proposed a technique, wherein a plurality of mirrors are arranged in a substantially ring shape on a conical surface, and two-dimensional images of the same displaying target viewed from different viewpoints therearound are projected onto the respective mirrors from a projector, and a screen that rotates with the center axis of this conical surface being as the axis of rotation is provided and a two-dimensional image is projected onto this screen, the two-dimensional image being reflected by a mirror that face this direction, whereby two-dimensional image projected onto this screen is changed with the rotation of the screen, and when a person views this screen while moving around the screen, the same images as the images of the displaying target viewed from different viewpoints corresponding to the viewing positions can be viewed, thus allowing for stereoscopic view (for example, see JP-A-2006-10852).

### SUMMARY OF THE INVENTION

Incidentally, the techniques described in JP-A-2001-103515 and JP-A-2002-27504 allow for stereoscopic view using afterimage, and it is therefore necessary to display slightly different images substantially simultaneously. This requires quite a large number of two-dimensional images, thus taking extraordinary time and effort to prepare these, and this also requires a large capacity memory for storing such two-dimensional image data. Moreover, because it is necessary to rotate the screen at high speed, two-dimensional image corresponding to the direction of this screen needs to be projected onto the screen with sufficient accuracy, and thus synchronization between the rotation of the screen and the timing of projection of the two-dimensional image onto this screen needs to be kept with high accuracy.

Moreover, the technique described in JP-A-2002-271820 also causes two-dimensional images to appear as a three dimensional image by exerting the afterimage of the naked eyes by projecting two-dimensional slide images onto a screen rotating at high speed, or by image-forming the two-dimensional images at a position in the surrounding space, the two-dimensional images being read from the cylindrical film by means of the mirror rotating at high speed. In the case of projecting this slide image onto the screen, as in the techniques described in JP-A-2001-103515 and JP-A-2002-27504, when the screen turns to the above-described viewpoint the corresponding slide image needs to be projected onto the screen, however, because the screen rotates at high speed, extremely high accuracy will be required in the timing of projection the slide images onto the screen.

In the technique described in JP-A-2002-271820, in the case where a three-dimensional image is displayed using two-dimensional images read from the above-described cylindrical film, a complicated means for such cylindrical film to sequentially read the images is required, and also because these images read from the cylindrical film are image-formed in the space, a clear three-dimensional image can be viewed only at this image-forming position and thus the view position is extremely limited.

On the other hand, in the technique described in JP-A-2006-10852, because the respective mirrors arranged in a ring shape on the conical surface just need to reflect an image viewed from the viewpoint in a determined direction of the displaying target, a clear stereoscopic image with high resolution can be viewed from any directions without taking into consideration the projection timing of the two-dimensional images.

However, although the same is true of the techniques described in Patent Documents 1 to 3, the technique described in JP-A-2006-10852 employs a configuration using a rotating screen, and therefore a space for allowing this screen to rotate is needed, the rotating drive unit for rotating such screen is needed and a space therefor is needed, and in addition, an electric power is also needed in order to rotate the screen.

The present invention has been made in view of such problems and is intended to provide stereoscopic display devices that achieve miniaturization and power-saving by eliminating the rotating mechanism and that allows a clear stereoscopic image with high resolution to be viewed from any directions without taking into consideration the projection timing of the two-dimensional images.

In order to achieve the above-described objectives, according to an aspect of the present invention, there is provided a stereoscopic display device, wherein a plurality of mirrors are arranged adjacent to each other, and each the respective mirrors are caused to reflect a planar real image of the same object viewed from a different direction; and wherein the position and direction of a corresponding mirror to the planar real image are set so that an mirror image of this image by each the respective mirrors is produced on the same axis.

According to another aspect of the present invention, the two mirrors are installed perpendicular to the horizontal plane, and the planar real images separately representing different side surfaces of the object are arranged in parallel with the opposing mirror, the planar real image facing the respective mirrors, and the distance between the mirror and the planar real image facing thereto and the angle between the two mirrors are set so that the mirror images of the planar real images by the respective mirrors are produced at the same position.

According to yet another aspect of the present invention, the two mirrors are provided, and for each mirror the planar real image is opposingly arranged on the horizontal plane, and the angle of inclination of the mirror with respect to the opposing planar real image and the angle between the two mirrors are set so that the mirror images of the planar real images by the respective mirrors are produced at the same position.

According to yet another aspect of the present invention, the planar real image facing the mirror on the left side of the two mirrors is an image of the object as viewed by the left eye, and the planar real image facing the mirror on the right side of the two mirrors is an image of the object as viewed by the right eye.

According to yet another aspect of the present invention, there is provided a stereoscopic display device including: a polygon mirror comprised of a mirror that is provided for each flat side surface of a polygonal conic surface; and an image sequence formed by arranging a planar real image facing each mirror of the polygon mirror along the circumference about a center axis of the polygonal conic surface, wherein the angle of the polygonal conic surface with respect to the surface of a corresponding image ring is set so that a mirror image by the corresponding mirror that faces the respective planar real images in the image sequence is produced at a position of the center axis of the polygonal conic surface.

According to yet another aspect of the present invention, the planar real images of the image sequence are arranged on the same plane.

According to yet another aspect of the present invention, the planar real images of the image sequence are inclined with respect to the same horizontal plane by the same angle, respectively.

According to yet another aspect of the present invention, there is provided a stereoscopic display device including; a polygon mirror comprised of a mirror that is provided for each flat side surface of a polygonal cylinder surface ; and an image sequence formed by arranging a planar real image facing each mirror of the polygon mirror along the circumference about the center axis of the polygonal cylinder surface, wherein the distance between the planar real image in a corresponding image ring and the mirror facing thereto is set so that a mirror image by the mirror that faces each the respective planar real images in the image sequence is produced at a position of the center axis of the polygonal cylinder surface.

According to yet another aspect of the present invention, the image sequence is an image ring in which the planar real images are arranged adjacent to each other along the entire circumference.

According to yet another aspect of the present invention, the image sequence is formed by arranging the planar real images adjacent to each other along a part of the circumference.

According to yet another aspect of the present invention, a light shielding plate for blocking reflected light from other mirrors is provided between the mirrors or between the planar real images.

According to yet another aspect of the present invention, the planar real images are displayed in separate flat panel displays, respectively.

According to yet another aspect of the present invention, all the planar real images are displayed on the same flat panel display.

According to yet another aspect of the present invention, all the planar real images are projected and displayed on the same screen by means of a projector.

According to the present invention, because a plurality of fixed mirrors allow a stereoscopic image to be displayed, a rotating mechanism is no longer needed, thus allowing for the miniaturization and power-saving, and also the projection timing of each frame image (planar real image) does not need to be taken into consideration, and in addition a clear stereoscopic image with an improved resolution will be obtained.

Other objects, features and advantages of the invention will become apparent from the following description of the embodiments of the invention taken in conjunction with the accompanying drawings.

### BRIEF DESCRIPTION OF THE DRAWINGS

FIGS. 1A to 1C are views explaining the principle of a stereoscopic display device according to the present invention.

FIGS. 2A and 2B are views showing a first embodiment of the stereoscopic display device according to the present invention.

FIGS. 3A and 3B are views schematically showing a planar real image in FIG. 2B.

FIGS. 4A to 4D are views for explaining the first embodiment of the stereoscopic display device according to the present invention.

FIG. 5 is a block diagram showing a specific example of the system configuration of the first embodiment shown in FIGS. 2A and 2B.

FIG. 6 is a flowchart showing a specific example of the operation of the system shown in FIG. 5.

FIG. 7 is a perspective view showing a modification example of the first embodiment shown in FIGS. 2A and 2B.

FIG. 8 is a block diagram showing a specific example of the system configuration of the modification example shown in FIG. 7.

FIG. 9 is a perspective view showing another modification example of the first embodiment shown in FIGS. 2A and 2B.

FIGS. 10A and 10B are views showing a second embodiment of the stereoscopic display device according to the present invention.

FIG. 11 is a view showing a specific example of an image ring displayed on a flat panel display in FIGS. 10A and 10B.

FIG. 12 is a view showing a third embodiment of the stereoscopic display device according to the present invention.

FIG. 13 is a perspective view showing a fourth embodiment of the stereoscopic display device according to the present invention.

FIG. 14 is a perspective view showing a fifth embodiment of the stereoscopic display device according to the present invention.

FIGS. 15A and 15B are views showing a sixth embodiment of the stereoscopic display device according to the present invention.

FIGS. 16A and 16B are views showing a seventh embodiment of the stereoscopic display device according to the present invention.

FIG. 17 is a view schematically showing a specific example of an image ring preparation device for preparing information of an image ring, the information being used in the second embodiment shown in FIGS. 10A and 10B, and the like.

FIG. 18 is a block diagram showing a specific example of a system configuration when the image ring preparation device shown in FIG. 17 is integrated with the stereoscopic display device according to the present invention.

FIG. 19 is a block diagram showing a specific example of a system configuration when the image ring preparation device shown in FIG. 17 is separated from the stereoscopic display device according to the present invention.

FIG. 20 is a view schematically showing another specific example of the image ring preparation device for preparing information of the image ring used in the second embodiment shown in FIGS. 10A and 10B, and the like.

### DETAILED DESCRIPTION OF THE EMBODIMENTS

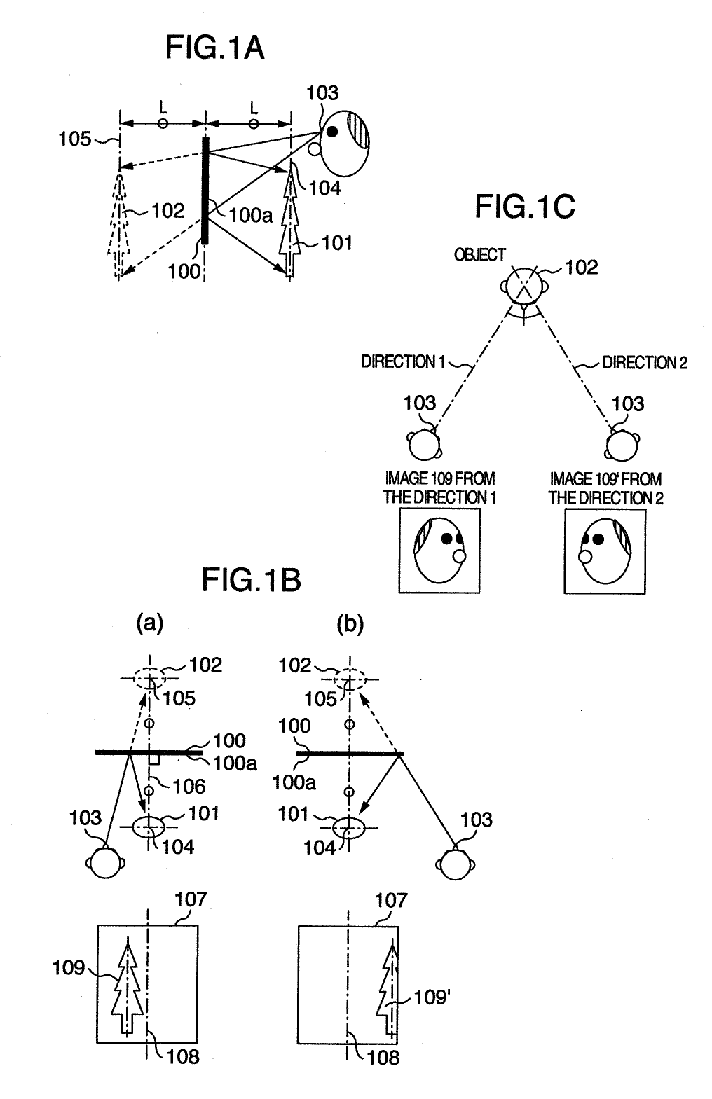

First, the principle of a stereoscopic display device according to the present invention is described using FIGS. 1A to 1C.

FIG. 1A is a view showing an arrangement relation between a mirror 100, object 101, and observer as seen from the side. Here, when the observer views the object 101 placed on near side (on a reflecting surface 100a side of the mirror 100 on the right side on the view) of the mirror 100 through the mirror 100, an image of this object 101 is reflected by the reflecting surface 100a of the mirror 100 and reaches the observer's eyes (viewpoint 103), thereby allowing this object 101 to be observed. As shown by the solid line arrow, the line of sight of the observer in this case starts from the viewpoint 103, and is reflected by the mirror surface 100a and reaches the object 101, thereby allowing the object 101 to be observed, however this means viewing the image (namely, mirror image 102) of the object 101 reflected on the mirror 100, and this mirror image 102 appears as if it exists on the rear side of the mirror 100.

Such mirror image 102 is assumed to be at a position symmetrical with the position of the object 101, with respect to the reflecting surface 100a of the mirror 100, and let the position of the object 101 be represented by a predetermined axis 104 and let the assumed position of the mirror image 102 corresponds to this be represented by an axis 105. The axis 104 and axis 105 are located on the opposite sides with respect to the reflecting surface 100a of the mirror 100 and also are located at the positions having an equal distance L from this reflecting surface 100a. In other words, the position of the mirror image 102 is determined from the positional relationship between the object 101 and the reflecting surface 100a of the mirror 100.

FIG. 1B is a view showing the arrangement relation of FIG. 1A as seen from the above, in which the axis 105 of the mirror image 102 is through the axis 104 of the object 101 and is located on an axis 106 perpendicular to the reflecting surface 100a of the mirror 100, and the distance from the axis 104 to the reflecting surface 100a is equal to the distance from the axis 105 to the reflecting surface 100a. Incidentally, the mirror image 102 is the left-to-right flipped object 101.

Now, as shown in FIG. 1B (a), assume that the viewpoint 103 (position of the observer's eyes) is located on the left side of the object 101 on the view and that the observer views the object 101 from this viewpoint position via the mirror 100, then the line of sight from this viewpoint 103 is diagonally reflected by the reflecting surface 100a of the mirror 100 and reaches the object 101, as shown by the solid line arrow. This means reaching the mirror image 102 from diagonally left side, as shown by the dotted line arrow. For this reason, the observer will see an object image 109 on the left side of a center line 108 corresponding to the axis 106 within his or her field of view 107. In addition, this object image 109 will be the object 101 viewed from slightly diagonally right as viewed from the mirror 100 side.

Similarly, as shown in FIG. 1B (b), assume that the viewpoint 103 (position of the observer's eyes) is located on the right side of the object 101 on the view and that the observer views the object 101 from this viewpoint position via the mirror 100, then the line of sight from this viewpoint 103 is diagonally reflected by the reflecting surface 100a of the mirror 100 and reaches the object 101, as shown by the solid line arrow. This means reaching the mirror image 102 from diagonally right, as shown by the dotted line arrow. For this reason, the observer will see an object image 109′ on the right side of the center line 108 corresponding to the axis 106 within his or her field of view 107. In addition, this object image 109 will be the object 101 viewed from slightly diagonally left as seen from the mirror 100 side, but when the line of sight reaches a portion near the right end of the reflecting surface 100a of the mirror 100, the object image 109′ will be the one lacking a part of the left side portion of the object 101.

In this way, when the object 101 is viewed via the mirror 100, the object 101 appears as if the position of the viewpoint with respect to the object differs depending on the position of the viewpoint 103 that is parallel with the reflecting surface 100a of the mirror 100. As shown in FIG. 1C, this fact is the same as the fact that when the position of the viewpoint 103 is changed in the circumferential direction about this object 101, with respect to the object 101, the object 101 appears as if the viewing direction changes. However, the case of FIG. 1B and the case of FIG. 1C are in the left-right-flipped relationship with respect to the object image.

The present invention is based on such principle, and allows for such stereoscopic view of an object by using the mirror images of the images obtained by imaging the object in place of using this object. Hereinafter, embodiments of the present invention will be described using the accompanying drawings.

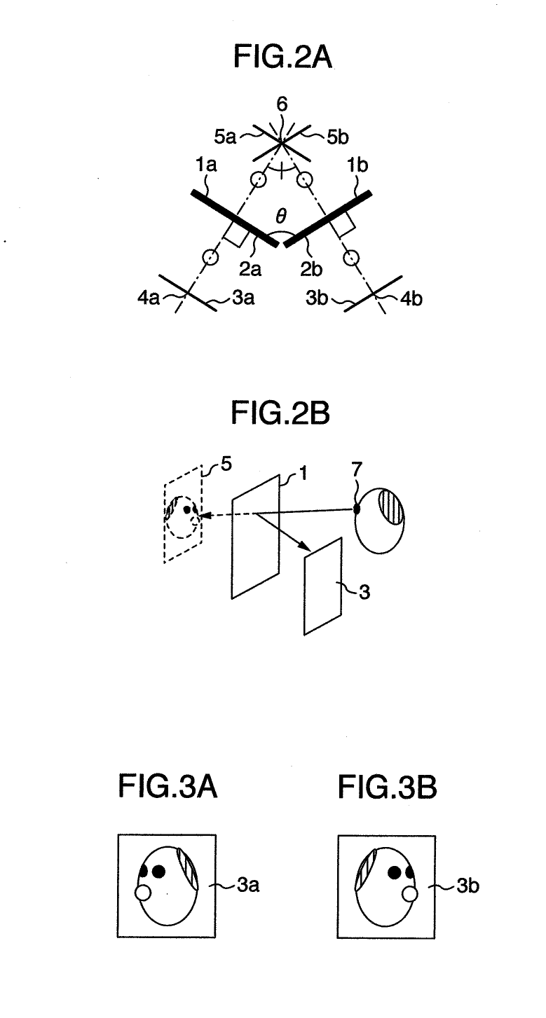

FIGS. 2A and 2B are views showing a first embodiment of the stereoscopic display device according to the present invention, FIG. 2A is a top view, and FIG. 2B is a side view of a part thereof, in which reference numerals 1, 1a, and 1b represent mirrors, reference numerals 2a and 2b represent reflecting surfaces, reference numerals 3, 3a, and 3b represent planar real images (two-dimensional images), reference numerals 4a and 4b represent real image center axes, reference numerals 5, 5a, and 5b represent planar mirror images, reference numeral 6 represents a mirror image center axis, and 7 represent an observer's viewpoint.

In FIG. 2A, two mirrors 1a and 1b are arranged in contact with each other at an angle θ. In addition, the surfaces of the mirrors 1a and 1b on a side where the angle from the mirror 1a to the mirror 1b forms (360°-θ) are the reflecting surfaces 2a and 2b, while the surfaces on the opposite side where the angle from the mirror 1a to the mirror 1b form θ are the rear surfaces of the mirrors 1a and 1b. Moreover, as shown as a mirror 1 in FIG. 2B, these mirrors 1a and 1b are installed so that the reflecting surfaces 2a and 2b are perpendicular to the horizontal plane.

On the reflecting surface 2a side of the mirror 1a, a planar real image 3a is arranged facing this reflecting surface 2a side, while on the reflecting surface 2b side of the mirror 1b, the planar real image 3b is arranged facing this reflecting surface 2b side. Here, as shown as a planar real image 3 in FIG. 2B, the planar real image 3a is in parallel with the reflecting surface 2a as a whole, but if the horizontal direction is in parallel with the reflecting surface 2a, the planar real image 3a may not be in parallel with the reflecting surface 2a in the vertical direction. The same is true of the planar real image 3b.

From such arrangement relation between the reflecting surface 2a of the mirror 1a and the planar real image 3a, a planar mirror image 5a with respect to this planar real image 3a will be produced on the rear surface side of this mirror 1a as shown as a mirror image 5 in FIG. 2B. The horizontal direction of the planar mirror image 5a is in parallel with the reflecting surface 2a of the mirror 1a, and this planar mirror image 5a is produced at a position symmetrical with the planar real image 3a, with respect to the reflecting surface 2a of the mirror 1a. As shown in FIG. 2B, this mirror image 5 is viewed as the observed image of the planar real image 3 in the mirror 1 from a viewpoint 7. Similarly, from the above-described arrangement relation between the reflecting surface 2b of the mirror 1b and the planar real image 3b, a planar mirror image 5b with respect to this planar real image 3b is produced on the rear surface side of this mirror 1b. The horizontal direction of the planar mirror image 5b is in parallel with the reflecting surface 2b of the mirror 1a, and this planar mirror image 5b is produced at a position symmetrical with the planar real image 3b, with respect to the reflecting surface 2b of the mirror 1b.

Here, the planar real images 3a and 3b are the images of the same object (including a human body such as a face) viewed from viewpoints in the different directions and are, for example, the images obtained by imaging the same object from different viewpoints. FIG. 3A, assuming the object is a portion of a human face, schematically shows the planar real image 3a obtained by imaging this object diagonally from slightly left side (as viewed from a person to be imaged, and hereinafter the same shall apply) of the front, and FIG. 3B schematically shows the planar real image 3b obtained by imaging the same human face portion from a direction diagonally viewed from slightly right side of the front.

In FIG. 2A, if such planar real image 3a is arranged on the mirror 1a side as described above, and such planar real image 3b is arranged on the mirror 1b side as described above, then the planar mirror image 5a of the planar real image 3a is produced by the mirror 1a and the planar mirror image 5a of the planar real image 3b is produced by the mirror 1b, and here, the angle θ, which the mirrors 1a and 1b form, and the positional relationship between the planar real images 3a and 3b with respect to the mirrors 1a and 1b are set so that these planar mirror images 5a and 5b are produced spatially equally.

More specifically, let the vertical center lines of the planar real images 3a and 3b be the real image's center lines 4a and 4b, then the angle θ which the mirrors 1a and 1b form and the positional relationship between the planar real images 3a and 3b with respect to the mirrors 1a and 1b are set so that the center lines corresponding to these real image center lines 4a and 4b in the planar mirror images 5a and 5b may coincide with each other (such center line is referred to as a mirror image center line 6).

Moreover, the planar real images 3a and 3b are the ones obtained by imaging the same object (in this case, a human face) by changing the imaging direction from the same distance so that the image of this object is located in the center within the imaging filed of view, and thus the sizes of the planar real images 3a and 3b are same.

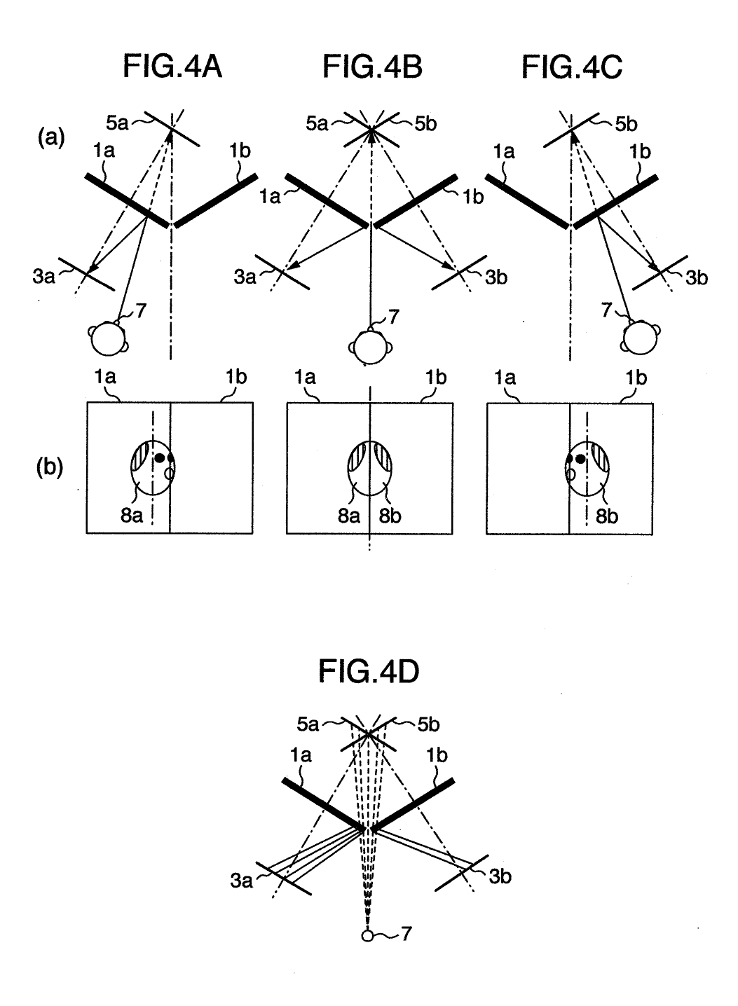

FIGS. 4A to 4C are views schematically showing how the planar real images 3a and 3b are seen by the mirrors 1a and 1b depending on the positions of the viewpoints with respect to the mirrors 1a and 1b, and FIG. 4B is a view showing the images (observed images) of the planar real images 3a and 3b that can be viewed through the mirrors 1a and 1b. Moreover, reference numerals 8a and 8b represent the observed images, and the parts corresponding to those of FIGS. 2A and 2B are given the same reference numerals to omit their duplicate description.

FIG. 4A shows the case when the viewpoint 7 is located on the mirror 1a side, which is the state where the image reflected on the mirror 1a of the planar real image 3a from the viewpoint 7, i.e., the planar mirror image 5a, can be viewed as the observed image 8a. As the viewpoint 7 moves to the mirror 1b side in the right direction on the view, the position in the mirror 1a where this planar mirror image 5a can be viewed, will also move in this direction, moving to the right end of the mirror 1a. FIG. 4A (a) shows the line of sight from the viewpoint 7 at this time, and FIG. 4A (b) shows the observed image 8a that can be viewed in the mirrors 1a and 1b at this time.

As the viewpoint 7 moves further rightward from the state shown in FIG. 4A, in the mirror 1a the observed image 8a moves further rightward and will disappear from the right side part thereof, and accordingly the image of the planar real image 3b, i.e., the planar mirror image 5b, starts to be reflected as the observed image 8b from the right side thereof at the left end portion of the mirror 1b, and thus the portion to be reflected will increase as moving rightward.

Here, the fact that the observed image 8a of the planar real image 3a can be viewed in the mirror 1a is equal to the fact that the light beam from the planar mirror image 5a of this planar real image 3a reaches the viewpoint 7 through this mirror 1a, and thus a portion of the planar mirror image 5a, to which such light beam will not goes through the mirror 1a, will not move to the mirror 1a and thus can not be viewed. Because the planar real image 3a is produced by the mirror 1a, the planar real image 3a is effective to this mirror 1a and the mirror 1b will not act on this planar mirror image 5a. Similarly, the fact that observed image 8b of the planar real image 3b can be viewed by the mirror 1b is equal to the fact that the light beam from the planar mirror image 5b of this planar real image 3b reaches the viewpoint 7 through this mirror 1b, and thus a portion of the planar mirror image 5b, to which such light beam will not pass through the mirror 1b, will not move to the mirror 1b and thus can not be viewed. Because the planar real image 3b is produced by the mirror 1b, the planar real image 3b is effective to this mirror 1b and the mirror 1a will not act on this planar mirror image 5b.

Then, when the viewpoint moved rightward from the state shown in FIG. 4A, as shown in FIG. 4B the light traveling toward the viewpoint 7 from a part of the planar mirror images 5a, i.e., from the right side portion, deviates from the mirror 1a and will not reach the viewpoint, and for this reason, in the mirror 1a the observed image 8a will be observed lacking the right side portion. Moreover, along with this, the light traveling from the right side portion of the planar mirror image 5b toward the viewpoint 7 will pass through the mirror 1b, and for this reason, the right side portion of the observed image 8b will start to be viewed from the left end of the mirror 1b.

Then, as shown in FIG. 4B (a), when the line of sight from the viewpoint 7 toward the mirror image center axis 6 is in the state of passing through the boundary between the mirrors 1a and 1b, the left half of the observed image 8a is reflected in the right end portion of the mirror 1a and the right half of the observed image 8b is reflected in the left end portion of the mirror 1b, as shown in FIG. 4B (b).

As the viewpoint 7 moves further rightward from the state shown in FIG. 4B, from the description in FIG. 4B and as shown in FIG. 4C, in the mirror 1a the observed image 8a will disappear from the right end of the mirror 1a, and in the mirror 1b the observed image 8b will move rightward and the whole thereof will be viewed. Then, finally, only the image of the planar real image 3b, i.e., the observed image 8b, can be viewed in the mirror 1b.

Thus, as the viewpoint 7 is moved in front of the mirrors 1a and 1b, at the beginning only the observed image 8a can be viewed in the mirror 1a, and then in the next state this observed images 8a is going to disappear and the observed image 8b of the planar real image 3b is going to be viewed in the mirror 1b, and finally only the observed images 8b of the planar real image 3b can be viewed in the mirror 1b, and thus the images viewed through the mirrors 1a and 1b move from the observed image 8a to the observed image 8b. Moreover, if the viewpoint 7 is moved in the direction opposite to the above-described one, the viewpoint 7 will move from the observed images 8b to the observed images 8a.

Here, as described above, the planar real images 3a and 3b are the images of the same object viewed from different directions with the distance being fixed, and the planar mirror images 5a and 5b of the planar real images 3a and 3b are configured so as to be produced at the same position, i.e., at the same mirror image center axis 6. Therefore, the sizes of the observed images 8a and 8b are equal, and the positions in the entire mirror comprised of the mirrors 1a and 1b are same, thereby allowing for smooth (continuous) movement from the observed image 8a to the observed image 8 and also allowing for smooth (continuous) movement from the observed images 8b to the observed images 8a.

Then, because the planar real images 3a and 3b are images of the same object viewed from different directions, the observed image 8a viewed in the mirror 1a and the observed image 8b viewed in the mirror 1b are the images of the same object viewed from different directions, and in addition, because the planar real image 3a is an image of this object viewed from diagonally left as seen from this object and similarly the planar real image 3b is an image viewed from diagonally right. Therefore, by moving the viewpoint 7 to the left side with respect to the mirrors 1a and 1b, the observed image 8a of the object as seen from diagonally left can be viewed, and by moving the viewpoint 7 to the right side, the observed image 8b of the object as seen from diagonally right can be viewed, thus achieving a stereoscopic view. In this manner, a stereoscopic image can be displayed with two static mirrors 1a and 1b.

In addition, the observed images 8a and 8b in this case are mirror images that are reflected and seen on the mirrors and thus are flipped left-to-right. On the other hand, the planar real image 3a with respect to the left side mirror 1a is made an image obtained by left-to-right flipping the image (FIG. 3B) of the object that is imaged from diagonally left as viewed from this object, and the planar real image 3b with respect to the right side mirror 1b is similarly made an image obtained by left-to-right flipping the image (FIG. 3A) of the object that is imaged from diagonally right, whereby by moving the viewpoint 7 to the left side, the observed image 8a of the object viewed from diagonally right as viewed from this object can be viewed, and by moving the viewpoint 7 to the right side, the observed image 8b of the object viewed from diagonally left as viewed from this object can be viewed, thus allowing the observer to feel like actually facing the object.

Moreover, the planar real images 3a and 3b may be photographs (in this case, the photographs are illuminated with an illumination means) or may be images displayed on a flat panel display, such as a liquid crystal display.

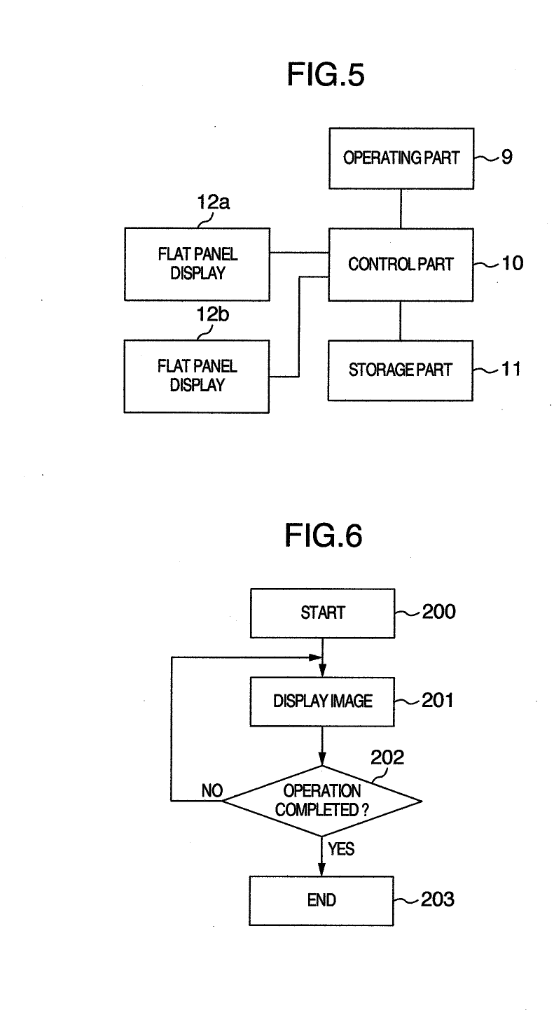

FIG. 5 is a block diagram showing a specific example of the system configuration of the first embodiment shown in FIGS. 2A and 2B, in which reference numeral 9 represents an operating part, 10 represents a control part, 11 represents a storage part, and reference numerals 12a and 12b represent flat panel displays.

Moreover, FIG. 6 is a flowchart showing a specific example of the operation of the system shown in FIG. 5.

This specific example uses flat panel displays as means for forming the planar real images 3a and 3b, and in FIG. 5 the image information of the planar real images 3a and 3b is stored in the storage part 11. Moreover, there are provided the flat panel display 12a for displaying the planar real image 3a in FIG. 2A and the flat panel display 12b for displaying the planar real image 3b.

Hereinafter, the operation of the first embodiment is described based on FIG. 6.

When the operation of the operating part 9 turns on the power supply to activate the control part 10 (Step 200), the control part 10 reads the image information for the planar real images 3a and 3b from the storage part 11 and provides the image information for the planar real image 3a to the flat panel display 12a to display the planar real image 3a as shown in FIG. 3A, and also provides the image information for the planar real image 3b to the flat panel display 12b to display the planar real image 3b as shown in FIG. 3B (Step 201). This allows for a stereoscopic view in FIGS. 2A and 2B, as described above.

Unless a completion operation is carried out in the operating part 9, the displaying of the planar real images in the flat panel displays 12a and 12b will continue, but once the completion operation is carried out in the operating part 9 (Step 202), the control part 10 terminates the displaying of the planar real images in the flat panel displays 12a and 12b and turns off the power supply (Step 203).

Because the directions of the mirrors 1a and 1b differ in this manner, the flat panel displays 12a and 12b for each mirror 1a and 1b are provided, whereby the planar real images 3a and 3b can be obtained for each mirror 1a and 1b, thus allowing for a stereoscopic view.

In addition, the planar real images 3a and 3b in this case may be prepared discretionarily with a computer graphic or the like, or may be imaged and prepared with a CCD camera as described later. Moreover, in imaging and preparing with a CCD camera, this preparation may be carried out in a remote site and the prepared image data may be received and stored in the storage part 11.

As described above, according to the first embodiment, because a stereoscopic view is enabled without using a rotating screen (mirror), and the space for and the driving unit for such rotating screen are not required, the miniaturization and power saving of the device can be achieved, and because planar real images are projected onto stationary mirrors, a clear stereoscopic image with high resolution can be obtained without taking into consideration the projection timing of two-dimensional images (planar real images) onto the mirrors.

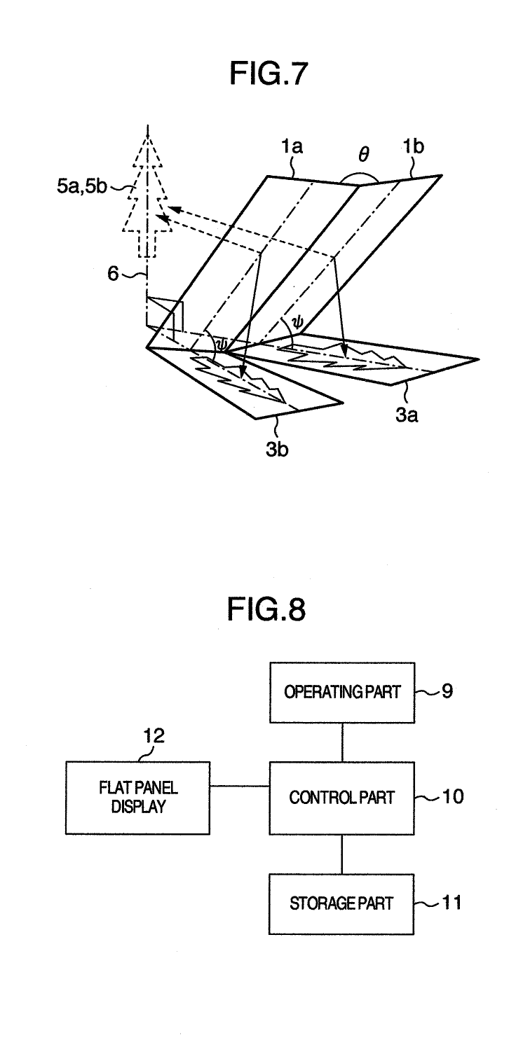

FIG. 7 is a perspective view showing a modification example of the first embodiment shown in FIGS. 2A and 2B, in which the parts corresponding to those of FIGS. 1A to 1C are given the same reference numerals to omit their duplicate description.

In FIG. 7, in this modification example, the planar real images 3a and 3b are arranged on the horizontal plane, and namely, the inclining angle φ with respect to the horizontal plane of the mirrors 1a and 1b, and the configuration angle θ between the mirrors 1a and 1b are set so that the planar mirror image 5a by the mirror 1a of the planar real image 3a and the planar mirror image 5b by the mirror 1b of the planar real image 3b may be produced at a position of the same mirror image center axis 6. For example, if the inclining angle □ is set to 45°, the mirror image center line 6 is perpendicular to the horizontal plane.

Also in this modification example, by making the planar real images 3a and 3b to be the same ones as the planar real images 3a and 3b in FIGS. 1A to 1C, the same effect as that of the first embodiment is obtained.

FIG. 8 is a block diagram showing a specific example of the system configuration of the modification example shown in FIG. 7, in which reference numeral 12 represents a flat panel display and the parts corresponding to those of FIG. 5 are given the same reference numerals to omit their duplicate description.

In FIG. 8, in this specific example, as a means for forming the planar real images 3a and 3b, a flat panel display 12 is used, and here the mirrors 1a and 1b (FIG. 7) are arranged facing the screen of this flat panel display 12. Moreover, the image information of these planar real images 3a and 3b is stored in the storage part 11.

Although the operation of such system is the same as the operation according to the flowchart shown in FIG. 6, the image information read from the storage part 11 is provided to the flat panel display 12, and with such image information the planar real images 3a and 3b are displayed simultaneously on the display screen of this flat panel display 12, as shown in FIG. 7.

In this way, this specific example allows for a stereoscopic view, and the same effect as that of the first embodiment is obtained.

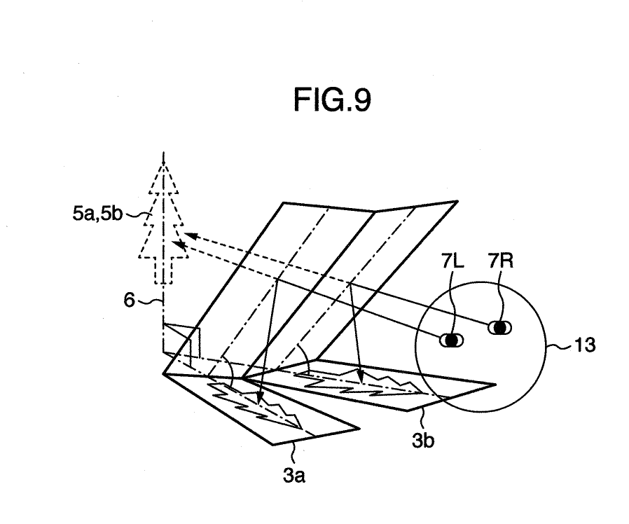

FIG. 9 is a perspective view showing another modification example of the first embodiment shown in FIGS. 2A and 2B, in which reference numeral 13 represents an observer, and the parts corresponding to those of the above-described drawings are given the same reference numerals to omit their duplicate description.

In FIG. 9, in this modification example, the planar real image 3a is an image of an object viewed by the left eye, and the planar real image 3b is an image of this same object viewed by the right eye. Moreover, the width and height of the mirrors 1a and 1b are determined so that when the observer 13 views the planar mirror images 5a and 5b in the mirrors 1a and 1b from a predetermined position, the observed image, i.e., the planar mirror image 5a in the mirror 1a, can be viewed by the left eye 7L and at the same time the observed image, i.e., the planar mirror image 5b in the mirror 1b, can be viewed by the right eye 7R.

In such modification example of the configuration, because the planar mirror image 5a of the planar real image 3a in the mirror 1a is viewed as the observed image by the left eye and at the same time the planar mirror image 5b of the planar real image 3b in the mirror 1b can be viewed by the right eye as the observed image, the planar mirror image 5b being located on the same mirror image center axis 6 as the planar mirror image 5a is located, an image of the object giving rise to these planar real images can be visually recognized as a three-dimensional (stereoscopic) image.

Note that, the use of such similar planar real images 3a and 3b allows for a similar stereoscopic view also in the stereoscopic display device having the configuration shown in FIGS. 1A to 1C.

Moreover, also in this specific example, the system configuration and operation thereof are the same as those of the specific example shown in FIG. 7, and the same effect as that of the first embodiment described above is obtained.

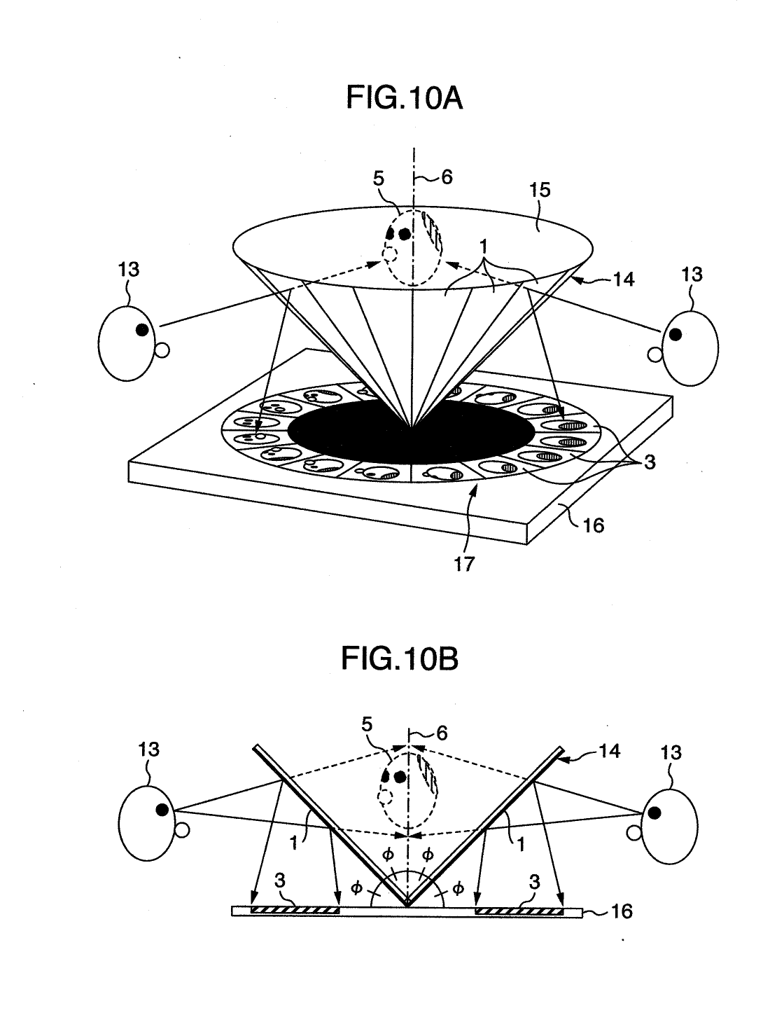

FIGS. 10A and 10B are views showing a second embodiment of the stereoscopic display device according to the present invention. FIG. 10A is a perspective view, and FIG. 10B is a vertical cross-sectional view, in which reference numeral 1 represents a mirror, 3 represents a planar real image, 5 represents a planar mirror image, 6 represents a mirror image center axis, 14 represents a polygon mirror, 15 represents a polygonal conic surface, 16 represents a flat panel display, and 17 represents an image ring.

In FIGS. 10A and 10B, on the upper surface of the flat panel display 16 forming a plane shape, along the perimeter of the polygonal conic surface 15 whose center axis serving as the mirror image center axis 6 is vertical, a plurality of isosceles triangular flat mirrors 1 are arranged adjacent to each other and such mirrors 1 form one polygon mirror 14. Here, this polygonal conic surface 15 forms a shape, in which a plurality of isosceles triangular flat side surfaces are sequentially arranged in the circumferential direction of the conical surface, wherein one mirror 1 in the polygon mirror 14 is positioned for each flat side surface of this polygonal conic surface 15. Then, this polygonal conic surface 15 is fixed to, for example, a non-illustrated ceiling part, or the like, so that the tip end side thereof is located on the upper surface side of the flat panel display 16 and the bottom surface thereof is located thereabove (hereinafter, such arrangement is referred to as a downward arrangement. Accordingly, an arrangement, in which the tip end side of the polygonal conic surface 15 is located above the flat panel display 16 and the bottom surface thereof is located on the upper surface side of the flat panel display 16, is an upward arrangement.) Accordingly, each mirror 1 is also arranged so that the isosceles triangular vertex side is located on the upper surface side of the flat panel display 16.

Moreover, on the upper surface of the flat panel display 16, a frame image as the planar real image 3 for each mirror 1 of the polygon mirror 14 is arranged in a ring shape along the same circumference about the axis 6 of the polygonal conic surface 15, whereby a sequence of frame images is displayed. Here, a sequence of these frame images is arrayed over this entire circumference, and such array is referred to as an image ring 17, in particular. Each planar real image 3 in this image ring 17 corresponds to a separate mirror 1, and is reflected by the corresponding mirror 1 so that the observer 13 can view. Namely, taking a look at two adjacent mirrors 1, these correspond to the mirrors 1a and 1b in FIG. 7 and FIG. 9.

Then, for the respective planar real images 3, the inclining angle (corresponding to the inclining angle θ in FIG. 2A) between the adjacent mirrors 1, accordingly the angle of inclination □ of the polygonal conic surface 15, and the like, are set so that all the planar mirror images 5 by the mirrors 1 are produced at a position of the same mirror image center axis 6. Here, as shown in FIG. 10B, this angle of inclination □ is set to 45°, and accordingly, the planar real image 3 is located on the horizontal plane, so that the positions of the planar mirror images 5 by all the mirrors 1 coincide with the mirror image center line 6 perpendicular to this horizontal plane. Therefore, the angle which each mirror 1 and the mirror image center line 6 form is also 45°.

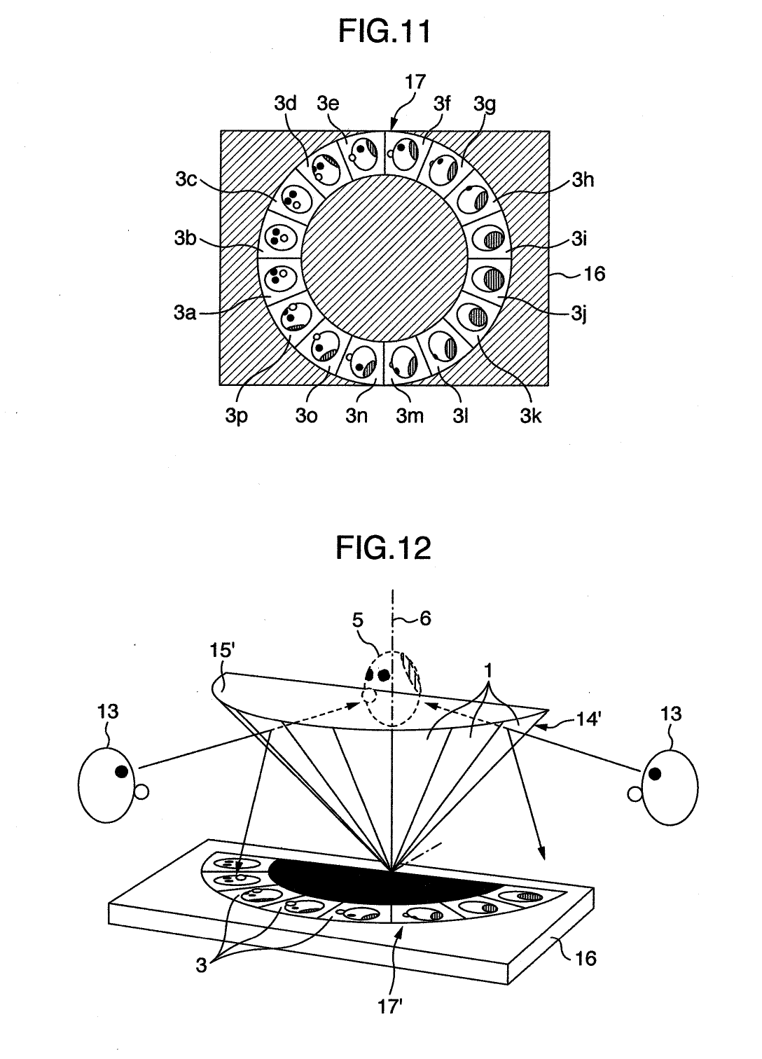

FIG. 11 shows a specific example of the image ring 17 displayed on this flat panel display 16, in which reference numerals 3a to 3p represent planar real images (frame images).

In FIG. 11, the image ring 17 is comprised of the planar real images 3a to 3p, which are a plurality of frame images arrayed in a ring shape, for example. These planar real images 3a to 3p are frame images of the same object viewed from different positions in the surrounding over the entire perimeter, respectively, and are arrayed in such order that the viewing direction varies. For example, if the planar real image 3a is a frame image viewed from the front of this object, then the planar real image 3i is the frame image of this same object viewed from right behind, and the positions in the projection image plane of these planar real images 3a to 3p correspond to the positions to view this object. These planar real images 3a to 3p are reflected by the separate mirrors 1 of the polygon mirror 14, respectively.

The image ring 17 may be prepared discretionarily with a computer graphic or the like, or may be imaged and prepared with a CCD camera as describe later. Moreover, in imaging and preparing with a CCD camera, this preparation may be carried out in a remote site and the prepared image data may be received and stored in the storage part 11.

The system configuration of the second embodiment is also the same as the system configuration shown in FIG. 8, and the operation thereof is also the same as that of the flowchart shown in FIG. 6.

As described above, also in the second embodiment, the need of a rotating screen (mirror) is eliminated, and the same effect as that of the first embodiment described above is obtained, and also mirror images viewed from viewpoints over 360° around the entire circumference of an object can be obtained.

FIG. 12 is a view showing a third embodiment of the stereoscopic display device according to the present invention, in which reference numeral 14′ represents a partial polygon mirror and 15′ represents a partial polygonal conic surface. Moreover, the parts corresponding to those of FIG. 10A are given the same reference numerals to omit their duplicate description.

Here, in the second embodiment shown in FIGS. 10A and 10B, the entire portions of 360° are used as the polygonal conic surface 15, but not necessarily limited thereto, and if images of 360° around an object are not to be viewed, namely when an object is to be viewed only from in front, then a part thereof may be used.

In the third embodiment shown in FIG. 12, by using the partial polygonal conic surface 15′ (namely, here, one of two parts, the two parts being obtained by dividing the polygonal conic surface into two at a plane including the center axis) whose circumferential side surface extends to 180°, the partial polygon mirror 14′ is formed, in which the isosceles triangular mirror 1 is arranged in the flat side surfaces, respectively. Accordingly, a half the number of mirrors 1 in the second embodiment shown in FIG. 10A will be arranged.

Moreover, the number of planar real images 3 displayed on the flat panel display 16 may be also a half the number of those in the second embodiment shown in FIG. 10A, and these planar real images 3 will be arrayed adjacent to each other along the half portion of the circumference. Here, such sequence of planar real images 3 is referred to as a half image ring 17′. This half image ring 17′ is comprised of the planar real images of an object viewed from the right lateral side, via the planar real images viewed from the front, through the planar real images viewed from the left lateral side, and taking FIG. 11 as an example, the planar real images 3m to 3p and the planar real images of 3a to 3e are displayed on this order.

The third embodiment provides the same effect as that of each the embodiments described above, and is used, for example, in the cases where there is no need to move around the rear side to view, such as the case where the device is disposed by the wall in a room, and the third embodiment can achieve further miniaturization by eliminating the unnecessary portions

In addition, in the third embodiment, as the sequence of frame images the half image ring 17′ along the 180° circular arc is used, but not limited thereto, and a sequence of frame images as the planar real images 3 along a circular arc larger than 180° or a circular arc smaller than 180° may be configured depending on the range to use the side surface in the polygonal conic surface (in such polygonal conic surface, the portion within this range where the side surface is not used in the polygonal conic surface having flat side surfaces around the entire circumference is excluded).

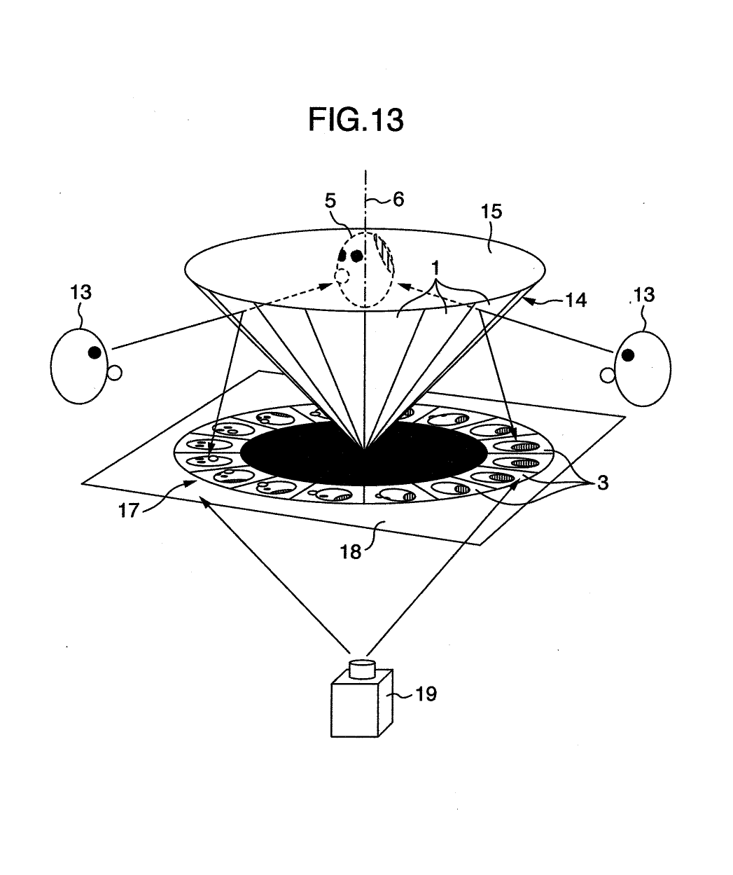

FIG. 13 is a perspective view showing a fourth embodiment of the stereoscopic display device according to the present invention, in which reference numeral 18 represents a screen and 19 represents a projector, and the parts corresponding to those of FIG. 10A are given the same reference numerals to omit their duplicate description.

In the second embodiment shown in FIGS. 10A and 10B, as the means to project the image ring 17 of planar real images 1, the flat panel display 16 is used, however in the fourth embodiment, as shown in FIG. 13, by using a screen 18 and a projector 19, the image ring 17 projected by the projector 19 is projected onto the screen 18.

The system configuration of the fourth embodiment also uses the projector 19 in place of the flat panel display 12 in FIG. 8, and the image information of the image ring 17 stored in the storage part 11 is read and projected by the projector 17.

With the above configuration, in the fourth embodiment, the same effect as that of the second embodiment shown in FIGS. 10A and 10B is obtained.

In addition, also in the fourth embodiment, as in the third embodiment shown in FIG. 12, a partial polygon mirror may be used, in which a plurality of mirrors are arrayed adjacent to each other in a partial polygonal conic surface of a part of the polygonal conic surface, thus providing the same effect as that of the third embodiment shown in FIG. 12.

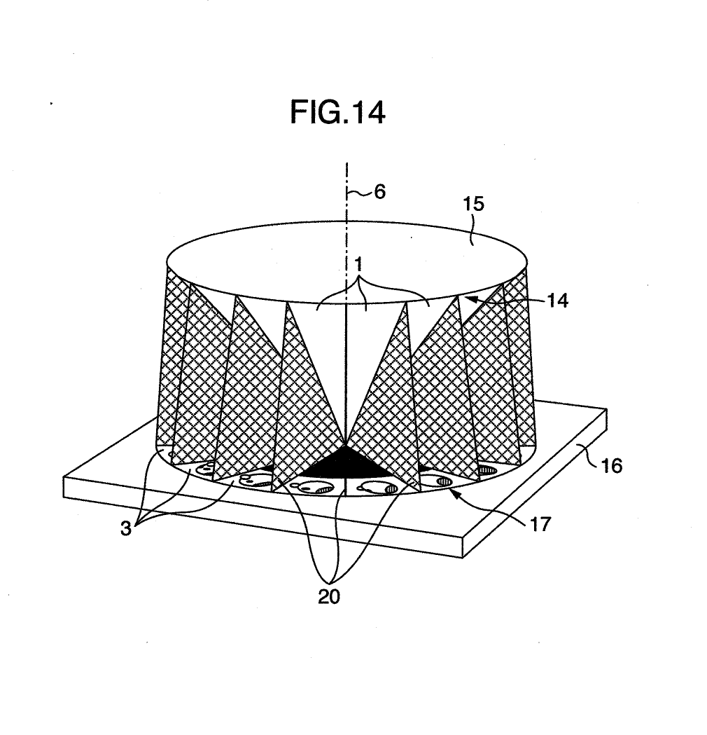

FIG. 14 is a perspective view showing a fifth embodiment of the stereoscopic display device according to the present invention, in which reference numeral 20 represents a light shielding plate, and the parts corresponding to those of FIGS. 10A and 10B are given the same reference numerals to omit their duplicate description.

In FIG. 14, in the fifth embodiment, a light shielding plate 20 is provided each between the mirrors 1 of the polygon mirror 14, whereby the reflected light from the mirrors 1 except the front mirror 1 through which the observer views a mirror image are blocked, and the mirror images of the other mirrors 1 are prevented from coming into the same field of view as that of the mirror image of the front mirror. Accordingly, only the mirror image of the front mirror 1 can be viewed without being interfered by the mirror images of the other mirrors 1, and thus depending on the direction to view the object, only the image viewed from this direction of the object can be viewed clearly.

In addition, in place of providing the light shielding plate 20 each between the mirrors 1, the light shielding plate may be provided each between the planar real images 3 of the image ring 17 and the same effect is obtained.

Alternatively, a view angle limiting filter may be provided in the mirror 1 or in the image ring 17. The view angle limiting filter is a structure made by inserting a fin-shaped thin light shielding plate vertically into a plate-shaped member made of a transparent material at a pitch of a half the plate thickness, whereby mirror images from the mirrors 1 except the mirror 1 through which an observer views are blocked from whichever direction the observer views the polygon mirror 14, and thus only the mirror image 5 in the corresponding mirror 1 in each direction can be viewed. Also in this case, the same effect as the one described above is obtained.

It is needless to say that the light shielding plate and view angle limiting filter described above can be applied to the above-described embodiments or to the embodiments described below.

Moreover, also in the fifth embodiment, as shown in FIG. 12, the partial polygon mirror 14′ may be employed, or as shown in FIG. 13 a configuration using the screen 18 and the projector 19 may be employed.

Moreover, the system configuration of the fifth embodiment is the same as that shown in FIG. 8.

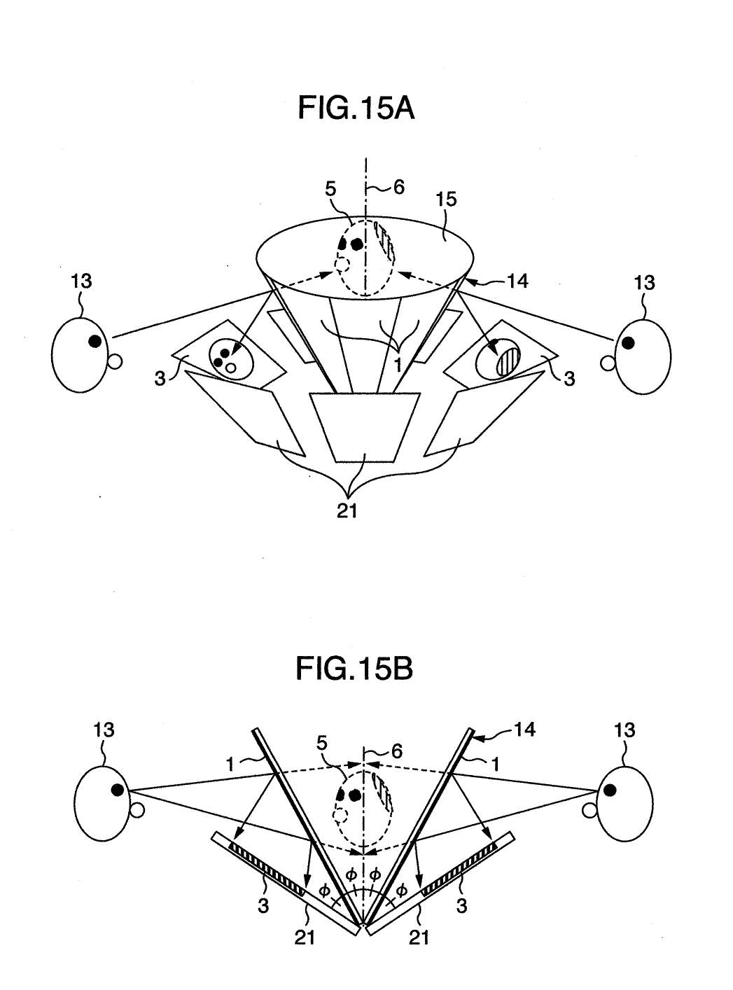

FIGS. 15A and 15B are views showing a sixth embodiment of the stereoscopic display device according to the present invention. FIG. 15A is a perspective view, and FIG. 15B is a vertical cross-sectional view, in which reference numeral 21 represents flat panel displays. Moreover, the parts corresponding to those of FIGS. 10A and 10B are given the same reference numerals to omit their duplicate description.

In FIGS. 15A and 15B, flat panel displays 21, such as liquid crystal displays, are separately provided facing the respective mirrors 1 of the polygon mirror 14. The planar real images 3 of the same object viewed from different directions are displayed in the display screens of the flat panel display 21, respectively, and the planar real image 3 to be displayed is the image corresponding to the direction to view the object. The respective mirrors 1 produce the mirror image 5 of such planar real image 3.

Here, as shown in FIG. 15B, the display surface of each flat panel display 3 is inclined with respect to the horizontal plane, and the angles which the center axis of the polygonal conic surface 15, in which the polygon mirror 14 is formed, and the respective mirrors 1 form are equally set to □, and the angle which the mirror 1 and the display surface of the flat panel display 21 facing thereto form is also equal to the angle φ which the center axis of the polygonal conic surface and the respective mirrors 1 form. Accordingly, all the mirror image center axises 6 of the mirror image 5 of the planar real images 3 by the mirrors 1 coincide with each other, resulting in the center axis of the polygonal conic surface 15.

In this sixth embodiment, the same effect as that of each the above-described embodiments is obtained, and furthermore the width in the horizontal direction of the device can be reduced and further miniaturization of the device can be achieved because each flat panel display 21 and mirror 1 are arranged to be inclined with respect to the horizontal plane.

In addition, also in this sixth embodiment, the partial polygonal conic surface as in the third embodiment shown in FIG. 12 allows a partial polygon mirror to be used.

Moreover, the system configuration of this sixth embodiment uses a plurality of flat panel displays as the system configuration shown in FIG. 5 does.

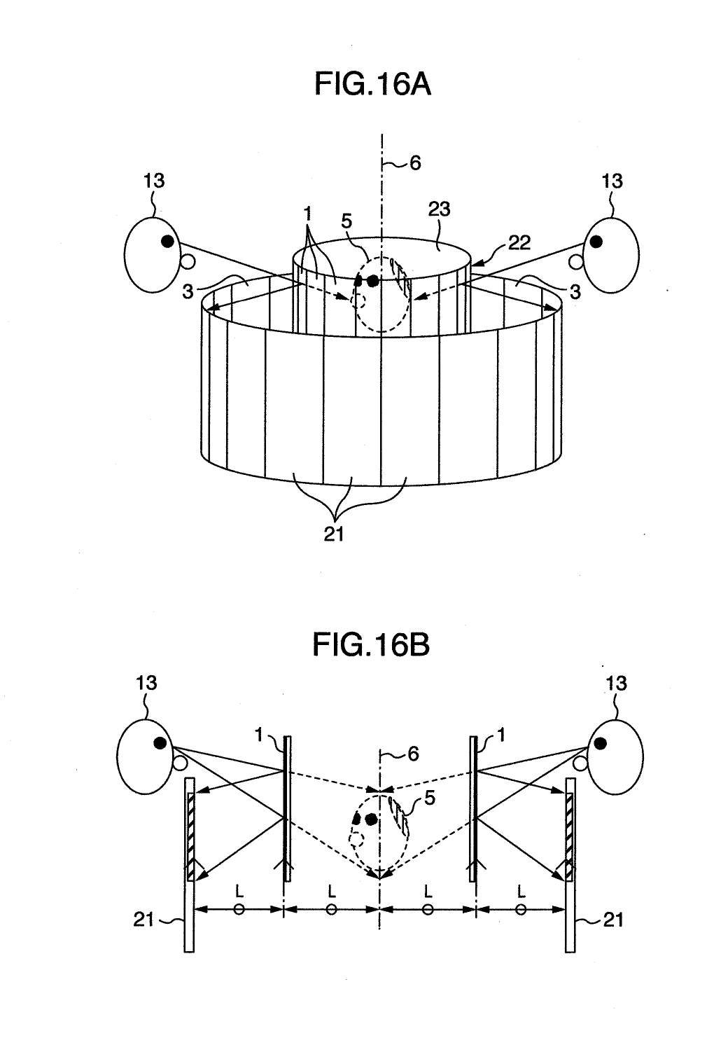

FIGS. 16A and 16B are views showing a seventh embodiment of the stereoscopic display device according to the present invention. FIG. 16A is a perspective view, and FIG. 16B is a vertical cross-sectional view, in which reference numeral 22 represents a polygon mirror and 23 represents a polygonal cylinder. Moreover, the parts corresponding to those of FIGS. 10A and 10B are given the same reference numerals to omit their duplicate description.

In FIGS. 16A and 16B, in this seventh embodiment, the mirror 1 is provided in the respective flat side surfaces of a polygonal cylinder surface 23 along the cylinder surface perpendicular to the non-illustrated horizontal plane, and a plurality of these mirrors 1 form the polygon mirror 22. Then, for each mirror 1 of this polygon mirror 22, the flat panel display 21 such as a liquid crystal display is separately provided facing thereto. The display screens of the flat panel display 21 are parallel to the opposing mirrors 1, respectively, and accordingly this display surface is perpendicular to the horizontal plane, and these display surfaces form a substantially polygonal cylinder surface.

In the respective flat panel displays 21, the planar real images 3 of the same object viewed from different directions are displayed, and the planar real image 3 to be displayed is the image corresponding to the direction to view the object. The respective mirrors 1 produce the mirror image 5 of such planar real images 3.

Here, as shown in FIG. 16B, the polygonal cylinder surface comprised of an array of display surfaces of the flat panel displays 21 is set so that the center axis thereof coincides with the center axis of the polygon mirror 22, and the distance between the display surface of each flat panel display 21 and the mirror 1 facing thereto is equal to the distance L between the polygon mirror 22 and the center axis thereof. In other words, the display surfaces of the flat panel displays 21 are set so that the center axes of the polygonal cylinder surface comprised of an array of display surfaces of the flat panel displays 21 and the center axes of the polygon mirror 22 coincide with each other and so that the radius of the polygon mirror 22 is equal to L and the radius of this polygonal cylinder surface is equal to 2 L.

With such configuration, all the mirror images 5 by the opposing mirrors 1 of the planar real images 3 that are displayed on the display surfaces of the respective flat panel displays 21 are produced at the same position, and these mirror image center axes 6 coincide with the center axis of the polygon mirror 22.

In addition, also in this seventh embodiment, the partial polygonal cylinder surface as in the third embodiment shown in FIG. 12 allows a partial mirror to be used.

In addition, in each the embodiments shown in FIGS. 10A to 15B, the polygonal conic surface 15 is set downwardly, but may be set upwardly. Moreover, the arrangement of the planar real images 3 will also be determined depending on such arrangement of the polygonal conic surface 15. For example, in the second embodiment shown in FIGS. 10A and 10B, if the polygonal conic surface 15 is set upwardly, the flat panel display 16 will be arranged above this polygonal conic surface 15 (on the non-illustrated ceiling side of the device).

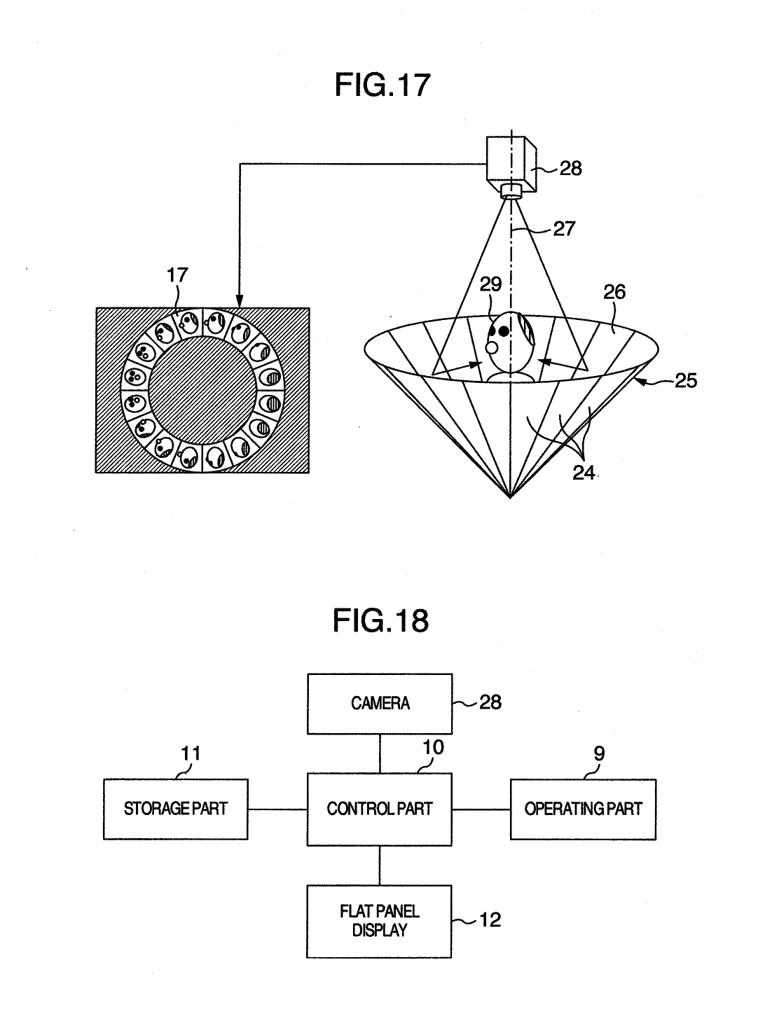

FIG. 17 is a view schematically showing a specific example of an image ring preparation device for preparing the information of image links, such as the image ring 17 (FIG. 11) used in the second embodiment shown in FIGS. 10A and 10B, and the like, in which reference numeral 24 represents a mirror, 25 represents a polygon mirror, 26 represents a polygonal conic surface, 27 represents a center axis, 28 represents a CCD camera, 29 represents an object (imaging target).

This specific example is suitable for a relatively small object for preparing an image ring.

In FIG. 17, the polygon mirror 25 comprises a plurality of isosceles triangular mirrors 24 arrayed on the polygonal conic surface 26, as the polygon mirrors 14 shown in FIGS. 10A and 10B do. Here, the object 29 serving as an object to be imaged is arranged about the center axis 27 of this polygonal conic surface 26. Moreover, above and along the center axis 27 of this polygonal conic surface 26, there is provided the CCD camera 28 with the bottom up (that is, the optical axis of a non-illustrated optical lens of the CCD camera 28 coincides with the center axis 27 of the polygonal conic surface 26). The whole polygon mirror 25 is included within the imaging field of view of this CCD camera 28. Each mirror 24 of the polygon mirror 25 corresponds to the direction to view the object 29, and an image of the object 29 reflected by each mirror 24 of the polygon mirror 25 is imaged by the CCD camera 28 as a frame image (planar real image), respectively. This provides the image information of the image ring 17 as shown in FIG. 11. In addition, the image imaged by the CCD camera 28 may be a still picture or a moving picture.

Here, the surface of the object 29 seen from the CCD camera 28 through the mirror 24 produces a difference depending on the angle of inclination of the mirror 24 and the distance from the CCD camera 28 to the object 29 (the height of the CCD camera 28), and for example, the above-described angle of inclination and distance are set so that the CCD camera 28 may image the object 29 from the horizontal direction.

In addition, in order to obtain an image sequence, in which the planar real images 3 are arranged along a part of the circular arc of the circumference, like the half image ring 17′ shown in FIG. 12, the same number of mirrors 24 as the number of planar real images of such image sequence may be used.

Such image ring preparation device may be installed in the vicinity of or integrally with the stereoscopic display device as shown in FIGS. 10A and 10B, so that the image information of the image ring obtained in this image ring preparation device is provided to this stereoscopic display device in real time and be displayed in three-dimensions. Such configuration allows an object as a valuable article, such as a jewelry, for example, to be displayed in three-dimensions as if the object itself is exhibited, without exposing the object to the outside.

FIG. 18 is a block diagram showing a specific example of the system configuration for this purpose, in which the parts corresponding to those of FIG. 8 and FIG. 17 are given the same reference numerals to omit their duplicate description.

In FIG. 18, when the operation of the operating part 9 turns on the power supply to activate the control part 10, the control part 10 operates the CCD camera 28 first, and as described in FIG. 17, and acquires the image ring 17 and stores this in the storage part 1. Upon completion of this operation, the control part 10 stops the operation of the CCD camera 28, and then reads the information of the image ring 17 from the storage part 11 and provide this to the flat panel display 12, and then, as described in FIGS. 10A and 10B, causes this display to display the image ring 17 and thus to display the mirror image stereoscopically.

In this way, each time the operation of the operating part 9 turns on the power supply, such operation is carried out, thus displaying the image ring 17 on the flat panel display 12. Accordingly, in order to display the mirror image of another object 29 in three dimensions, just replacing the object 29, which has been used, with another new object 29 allows for a stereoscopic view of this mirror image. In addition, while the mirror image is displayed, the CCD camera 28 can be kept in a non-operating state, i.e., at power off state, the power consumption spent on the CCD camera 28 also can be eliminated.

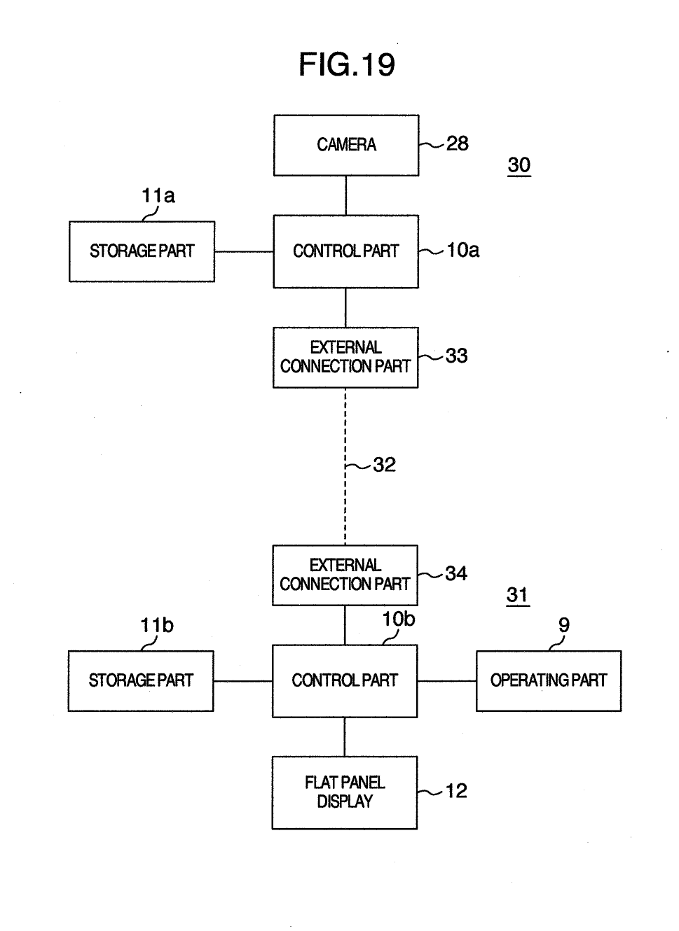

FIG. 19 is a block diagram showing a specific example of a system configuration when the image ring preparation device shown in FIG. 17 is separated from the stereoscopic display device of the above-described embodiments, in which reference numerals 10a and 10b represent control parts, 11a and 11b represent storage parts, reference numeral 30 represents an image ring preparation device, 31 represents a stereoscopic display device, 32 represents a network, reference numerals 33 and 34 represent external connection parts, and the parts corresponding to those of the above-described drawings are given the same reference numerals to omit their duplicate description.

In FIG. 19, the image ring preparation device 30 and the stereoscopic display device 31 are installed in sites a long-distance away from each other, and these are communicatably connected by the respective external connection parts 33 and 34 via the network 32. In addition, the network 32 may be a cable or may be a wireless.

When the operation of the operating part 9 in the stereoscopic display device 31 turns on the power supply, the control part 10b is activated to firstly request the image ring preparation device 30 for the information of an image ring. This request information is sent from the external connection part 34 to the image ring preparation device 30 via the network 32. In the image ring preparation device 30, upon receipt of this request information from the external connection part 33, the control part 10a is activated to operate the CCD camera 28, thereby obtaining the information of the image sequence (here, represented by the image ring 17 shown in FIG. 11) and storing this in the storage part 11a. Thereafter, the control part 10a stops (powers off) the operation of the CCD camera 28, and reads the stored information of the image ring 17 from the storage part 11a and transmits this from the external connection part 33 to the stereoscopic display device 31 via the network 32.

Then, in the stereoscopic display device 31, upon receipt of this information of the image ring 17 by the external connection part 34, the control part 10b stores this information of the image ring 17 in the storage part 11b, and thereafter reads this and provides this to the flat panel display 12 to cause this to display the image ring 17.

In addition, in the stereoscopic display device 31, the control part 10b checks the reception of the information of the image ring 17 and the storing into the storage device 11b, and if either one of these is not carried out successfully, the control part 10b requests again the image ring preparation device 33 for the information of the image ring 17 (in this case, in the image ring preparation device 30, the information of the image ring 17 is read again from the storage part 11a, or the CCD camera 28 is operated again to form the image ring 17 again, and then the information of the image ring 17 is transmitted to the stereoscopic display device 31). However, if both the reception of the information of the image ring 17 and the storing into the storage device 10b are carried out successfully, the control part 10b sends a notification information indicative of this fact to the image ring preparation device 30, and accordingly the image ring preparation device 30 is set to the power off state.

As described above, in the specific example of this system configuration, the information of the image ring 17 used in the stereoscopic display device of each embodiment of the present invention can be prepared even at a place sufficiently away from this stereoscopic display device, and thus even for an object as an imaging target that can not be moved or is not allowed to be moved, a stereoscopic vision image can be displayed in real time.

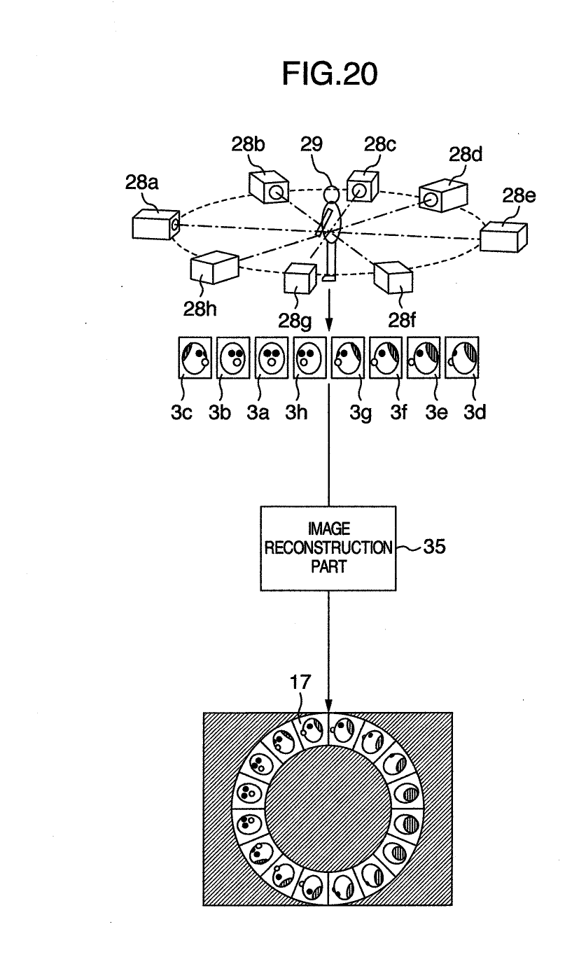

FIG. 20 is a view schematically showing another specific example of the image ring preparation device for preparing the information of an image link, such as the image ring 17 (FIG. 11) that is used in the second embodiment shown in FIGS. 10A and 10B, in which reference numerals 3a to 3h represent frame images, 28a to 28h represent CCD cameras, reference numeral 35 represents an image reconstruction part, and the parts corresponding to those of the above-described drawings are given the same reference numerals to omit their duplicate description.

The image ring preparation device shown in FIG. 17 cannot be used if an object as the imaging target is large or if an object as the imaging target can not be moved. This specific example shown in FIG. 20 can be applicable even under such conditions.

In FIG. 20, a plurality of CCD cameras 28a to 28h (in this case, eight pieces) are arranged at equal intervals on the circumference about the object 29 of an imaging target. All the imaging directions of these CCD cameras 28a to 28hs, i.e., the optical axes of the optical lens system, are directed to the center of this circumference, i.e., to the object 29.

Then, these CCD cameras 28a to 28h image the object 29 from the mutually different directions, and from these CCD cameras 28a to 28h the frame images 3a to 3h are obtained, respectively. These frame images 3a to 3h are array-processed into a ring shape in an array corresponding to the array of the corresponding CCD cameras 28a to 28h by the image reconstruction part 35, thus preparing the information of the image ring 17.

Here, the CCD cameras 28a to 28h are separately portable, respectively, and can be arrayed depending on the position and size of the object 29 as described above.

The system configuration of this specific example is also the same as the system configuration shown in FIG. 19, in which the control part 10a in the image ring formation part 30 also includes the function of the image reconstruction part 35.

In addition, also in this specific example, by arranging a plurality of CCD cameras within a predetermined range of a part of the surrounding of the object 29 as described above, an arc-shaped image sequence such as the half image ring 17′ shown in FIG. 12 can be obtained.

Moreover, for the first embodiment shown in FIGS. 2A and 2B and the specific examples shown in FIG. 7 and FIG. 9, two mirrors 24 may be used in FIG. 17 and two CCD cameras may be used in FIG. 20.

Moreover, by mounting also an external storage medium and including a reproducing function into the storage part 11b in FIG. 5, FIG. 8, and FIG. 18, or into the storage part 11 in FIG. 19a, it is possible for this storage part 11 or storage part 11b to read, from the external storage medium, in which the information of an image ring prepared, for example, by a three-dimensional computer graphic is stored, this information and provide this to the flat panel display.

It should be further understood by those skilled in the art that although the foregoing description has been made on embodiments of the invention, the invention is not limited thereto and various changes and modifications may be made without departing from the spirit of the invention and the scope of the appended claims.

1. A stereoscopic display device,
wherein a plurality of mirrors are arranged adjacent to each other, and each mirror is set to reflect a planar real image of the same object viewed from a different direction; and
wherein the position and direction of a corresponding mirror to the planar real image are set so that a mirror image of this image by each mirror is produced on the same axis.

2. The stereoscopic display device according to claim 1,
wherein the two mirrors are installed perpendicular to the horizontal plane, and the planar real images separately representing different side surfaces of the object are arranged in parallel with the opposing mirrors, the planar real images facing the respective mirrors, and
wherein the distance between the mirror and the planar real image facing thereto and the angle between the two mirrors are set so that mirror images of the planar real images by the respective mirrors are produced at the same position.

3. The stereoscopic display device according to claim 1,
wherein the two mirrors are provided, and for each mirror the planar real image is opposingly arranged on the horizontal plane, and
wherein the angle of inclination of the mirror with respect to the opposing planar real image and the angle between the two mirrors are set so that the mirror images of the planar real images by the respective mirrors are produced at the same position.

4. The stereoscopic display device according to claim 3, wherein the planar real image facing the mirror on the left side of the two mirrors is an image of the object as viewed by the left eye, and the planar real image facing the mirror on the right side of the two mirrors is an image of the object as viewed by the right eye.

5. A stereoscopic display device, comprising:
a polygon mirror comprised of mirrors each provided for each flat side surface of a polygonal conic surface; and
an image sequence formed by arranging a planar real image facing each mirror of the polygon mirror along the circumference of a center axis of the polygonal conic surface,
wherein the angle of the polygonal conic surface with respect to the surface of a corresponding image ring is set so that a mirror image by a corresponding mirror facing the respective planar real images in the image sequence is produced at a position of the center axis of the polygonal conic surface.

6. The stereoscopic display device according to claim 5, wherein the planar real images of the image sequence are arranged on the same plane.

7. The stereoscopic display device according to claim 5, wherein each planar real image of the image sequence is inclined with respect to the same horizontal plane by the same angle, respectively.

8. A stereoscopic display device, comprising;
a polygon mirror comprised of mirrors provided for each flat side surface of a polygonal cylinder surface; and
an image sequence formed by arranging a planar real image facing the each mirror of the polygon mirror along the circumference of a center axis of the polygonal cylinder surface,
wherein the distance between the planar real image in a corresponding image ring and the mirror facing thereto is set so that a mirror image by the mirror facing each the respective planar real images in the image sequence is produced at a position of the center axis of the polygonal cylinder surface.

9. The stereoscopic display device according to claim 5, wherein the image sequence is an image ring in which the planar real images are arranged adjacent to each other along the entire circumference.

10. The stereoscopic display device according to claim 5, wherein the image sequence is formed by arranging the planar real images adjacent to each other along a part of the circumference.

11. The stereoscopic display device according to claim 5, wherein a light shielding plate for blocking reflected light from other mirrors is provided between the mirrors or between the planar real images.

12. The stereoscopic display device according to claim 6, wherein a light shielding plate for blocking reflected light from other mirrors is provided between the mirrors or between the planar real images.

13. The stereoscopic display device according to claim 7, wherein a light shielding plate for blocking reflected light from other mirrors is provided between the mirrors or between the planar real images.

14. The stereoscopic display device according to claim 8, wherein a light shielding plate for blocking reflected light from other mirrors is provided between the mirrors or between the planar real images.

15. The stereoscopic display device according to claim 9, wherein a light shielding plate for blocking reflected light from other mirrors is provided between the mirrors or between the planar real images.

16. The stereoscopic display device according to claim 10, wherein a light shielding plate for blocking reflected light from other mirrors is provided between the mirrors or between the planar real images.

17. The stereoscopic display device according to claim 2, wherein the planar real images are displayed in separate flat panel displays, respectively.

18. The stereoscopic display device according to claim 3, wherein all the planar real images are displayed on the same flat panel display.

19. The stereoscopic display device according to claim 3, wherein all the planar real images are projected and displayed on the same screen by means of a projector.
